(19) United States
(12) Patent Application Publication
(10) Pub. No.: US 2022/0237896 A1
(43) Pub. Date: Jul. 28, 2022

(54) METHOD FOR TRAINING A MODEL TO BE USED FOR PROCESSING IMAGES BY GENERATING FEATURE MAPS

(71) Applicants: TOYOTA MOTOR EUROPE, Brussels (BE); MAX-PLANCK-INSTITUT FÜR INFORMATIK, Saarbrücken (DE)

(72) Inventors: Yang He, Saarbrücken (DE); Mario Fritz, Saarbrücken (DE); Bernt Schiele, Saarbrücken (DE); Daniel Olmeda Reino, Brussels (BE)

(21) Appl. No.: 17/614,903

(22) PCT Filed: May 31, 2019
(86) PCT No.: PCT/EP2019/064241

§ 371 Date: Nov. 29, 2021

(51) Int. Cl. G06V 10/774; G06V 10/82; G06V 10/26; G06V 10/77; G06V 10/44; G06V 20/56

(52) U.S. Cl. CPC G06V 10/774; G06V 10/82; G06V 20/56; G06V 10/7715; G06V 10/454; G06V 10/26

(57) ABSTRACT

A method for training a model to be used for processing images, wherein the model comprises: —a first portion (101) configured to receive images as input and configured to output a feature map, —a second portion (102) configured to receive the feature map outputted by the first portion as input and configured to output a semantic segmentation, the method comprising: —training a generator (201) so that the generator is configured to generate a feature map configured to be used as input to the second portion, —generating a plurality of feature maps using the generator, —training the second portion using the feature maps generated by the generator.

### CROSS-REFERENCE TO RELATED APPLICATIONS

This application is a National Phase of International Application No. PCT/EP2019/064241 filed May 31, 2019, the entire contents of which are herein incorporated by reference.

### FIELD OF THE DISCLOSURE

The present disclosure relates to the field of image processing using models such as neural networks.

### DESCRIPTION OF THE RELATED ART

A known image processing method using models such as neural networks is semantic segmentation.

Semantic segmentation is a method for determining the types of objects which are visible (or partially visible) in an image, by classifying each pixel of an image into one of many predefined classes or types. For example, the image may be acquired by a camera mounted in a vehicle. Semantic segmentation of such an image allows distinguishing other cars, pedestrians, traffic lanes, etc. Therefore, semantic segmentation is particularly useful for self-driving vehicles and for other types of automated systems. Semantic segmentation may be used in scene understanding, perception, robotics, and in the medical field.

Semantic segmentation methods typically use models such as neural networks or convolutional neural network to perform the segmentation. These models have to be trained.

Training a model typically comprises inputting known images to the model. For these images, a predetermined semantic segmentation is already known (an operator may have prepared the predetermined semantic segmentations of each image by annotating the images). The output of the model is then evaluated in view of the predetermined semantic segmentation, and the parameters of the model are adjusted if the output of the model differs from the predetermined semantic segmentation of an image.

It follows that in order to train a semantic segmentation model, a large number of images and predetermined semantic segmentations are necessary.

Various approaches have been proposed to avoid having to annotate images by hand or to limit the quantity of work to be done by an operator.

For example, it has been proposed to use flipping or re-scaling of images to make full use of an annotated data set.

With the recent improvements of graphic engines, is has been proposed to generate synthetic images to be used for training neural networks. However, using synthesized images for semantic images remains a challenge: it is difficult to represent complex scenes, and the exponential number of combinations of elements visible on an image.

It has been proposed to use synthetic images to reduce the distribution gap been synthetic images and real images so as to solve domain adaptation problems.

Using synthetic images to train neural networks has also been proposed, using high resolution images. However, it has been observed that these methods do not show an improvement in the quality of the semantic segmentation with respect to a training done only with real images. This may be caused by the presence of visual artifacts which affect low-level convolutional layers and lead to a decrease in semantic segmentation performance.

Generation of synthetic images can be performed using Generative Adversarial Networks (GAN), as proposed in “Generative adversarial nets” (I. J. Goodfellow, J. P.-Abadie, M. Mirza, B. Xu, D. W.-Farley, S. Ozair, A. Courville, and Y. Bengio, NIPS 2014, https://arxiv.org/pdf/1406.2661.pdf, Advances in neural information processing systems, pages 2672-2680, 2014).

GAN proposes to use two neural networks, a generator network and a discriminator network, in an adversarial manner.

For example, it has been proposed to input class labels (that define the types of objects visible on images) into a generator in a GAN approach so as to generate synthetic images. However, this solution is not satisfactory.

The above problems also apply to models processing images for methods other than semantic segmentation, for example in object detection or in depth estimation or various other methods.

### SUMMARY OF THE DISCLOSURE

The present disclosure overcomes one or more deficiencies of the prior art by proposing a method for training a model to be used for processing images, wherein the model comprises:
a first portion configured to receive images as input and configured to output a feature map,
a second portion configured to receive the feature map outputted by the first portion as input and configured to output a processed image, the method comprising:
training a generator so that the generator is configured to generate a feature map configured to be used as input to the second portion,
generating a plurality of feature maps using the generator,
training the second portion using the feature maps generated by the generator processed images.

Thus, the present disclosure proposes to use a generator which will not generate images in a GAN approach, but feature maps which are intermediary outputs of the model.

The model may have the structure of a convolutional neural network. The person skilled in the art will be able to select a convolutional neural network suitable for the image processing to be performed.

The person skilled in the art may be able to determine where the first portion of the model ends and where the second portion starts in the model through testing, for example by determining which location outputting a feature map leads to an improvement in the training.

By way of example, the first portion may be substantially an encoder and the second portion may be substantially a decoder, using expressions well known to the person skilled in the art.

In a model such as a neural network, an encoder is a first portion of a neural network which is used to compress and extract useful information and a decoder is used to recover the information from the encoder to desired outputs. Typically, the encoder outputs the most compressed feature map.

In the above method, the expression “processed image” refers to the output of the second portion of the model. For example, if the model is a model for semantic segmentation, the processed image is a semantic segmentation of an image. A semantic segmentation is a layout indicating the type of an object for each pixel in this layout. For example, types of objects may be chosen in a predefined list.

The expression “feature map” designates the output of a layer of a model such as a convolutional neural network. Typically, for a convolutional neural network, a feature map is a matrix of vectors, each vector being associated with a neuron of the layer which has outputted this feature map (i.e. the last layer of the portion of the neural network outputting this feature map).

In the above method, the last layer of the first portion outputs the feature map.

The inventors of the present disclosure have observed that using a generator to output a feature map allows obtaining dense features: features which have a large number of channels and possibly a lower resolution than an input image. The number of channel is the depth of the matrix of vectors outputted by the last layer of the first portion. These dense features therefore encode both location information and useful details in a precise manner. Thus, training of the second portion (and therefore of the model) is improved using generated feature maps.

It could also be noted that these feature maps have a matrix of vectors structure in which there are correlations between vectors from different locations. These feature maps or dense features encode both location information and useful details, which improves using generated feature maps.

Accordingly, the separation in the model between the first portion and the second portion may be chosen so that the feature map has a depth superior to 3 (the number of channels of a Red-Green-Blue image) and a resolution inferior to the ones of the images which may be inputted to the model.

In some embodiments, the generator is a multi-modal generator. A multi-modal generator is able to output a plurality of synthetic feature on the basis, for example, of a single processed image.

According to a particular embodiment, the generator is trained with an adversarial training.

It has been observed by the inventors that a GAN approach can be used to generate feature maps on the basis of a predefined processed image. This processed image can be used as input to the generator. Alternatively, other inputs may be used for the generator, for example: depth maps (distance of object to the camera), normal maps (surface of scenes of objects), instance segmentations (a layout in which pixels belonging to distinct objects are classified according to the different objects they belong to regardless of the type of the object), or any combination of these possible inputs to the generator.

It should be noted that a semantic segmentation is a layout indicating the type of an object for each pixel in this layout. For example, types of objects may be chosen in a predefined list.

According to a particular embodiment, the method comprises a preliminary training of the model using a set of images and, for each image of the set of image, a predefined processed image.

This set of images may be a set of real images, for example acquired by a camera. The processed images may be obtained by hand by a user. For example, if the model is a model for semantic segmentation, the preliminary training may be performed using the set of images and for each image, a predefined processed image.

According to a particular embodiment, training the generator comprises using the predefined processed images (associated with images from the set of images) as input to the generator.

According to a particular embodiment, training the generator comprises using processed images obtained using the model on images from the set of images.

For example, the processed images may be inputted to the generator.

According to a particular embodiment, training the generator comprises using feature maps obtained using the first portion on images from the set of images.

According to a particular embodiment, training the generator comprises inputting an additional random variable as input to the generator.

By way of example, the additional random variable is chosen from a gaussian distribution. Alternatively, other types of distributions may be used.

Inputting an additional random variable to the generator allows obtaining different generated feature maps from a same processed image used as input if processed images are used as inputs. This increases the number of usable feature maps that can be used to train the second portion.

For example, using this random variable may be used to implement the method known to the person skilled in the art as the latent vector method. This method has been disclosed in document “Auto-Encoding Variational Bayes” (Diederik P Kingma, Max Welling, The 2nd International Conference on Learning Representations (ICLR), 2013).

According to a particular embodiment, the generator comprises a module configured to adapt the output dimensions of the generator to the input size of the second portion.

This allows obtaining usable feature maps if the generator does not produce matrixes of vectors having the appropriate dimensions.

By way of example, the module configured to adapt the output dimensions of the generator comprises an atrous spatial pyramid pooling module.

Atrous spatial pyramid pooling has been disclosed in “DeepLab: Semantic Image Segmentation with Deep Convolutional Nets, Atrous Convolution, and Fully Connected CRFs” (L.-C. Chen, G. Papandreou, I. Kokkinos, K. Murphy, and A. L. Yuille, arXiv preprint arXiv:1606.00915, 2016).

Using an atrous spatial pyramid pooling module allows effectively aggregating multi-scale information. Multi-scale information refers to the different types of information which are visible at different scales. For example, in an image, entire objects can be visible at a large scale while the texture of objects may only be visible at smaller scale.

According to a particular embodiment, the generator comprises a convolutional network. For example, this convolutional network may be a “U-net”, as disclosed in “U-net: Convolutional networks for biomedical image segmentation” (O. Ronneberger, P. Fischer, and T. Brox., MICCAI, 2015).

It has been observed that a U-net leverages low-level features for generating features which contains rich detailed activations, which makes the U-net a good network for generating the above-mentioned feature maps.

According to a particular embodiment, training the generator with an adversarial training comprises using a discriminator receiving a processed image as input, the discriminator comprising a module configured to adapt the dimensions of the processed image to be used as input.

For example, this module may adapt the dimensions of the processed image to the dimensions of the first module following the module configured to adapt the dimensions in the discriminator.

Also, the module configured to adapt the dimensions of the processed image to be used as input to the discriminator may be an atrous spatial pyramid pooling module.

It has been observed that this module can receive a high resolution processed image (for example a high resolution semantic segmentation) and that the atrous spatial pyramid pooling module ensures that multi-scale information is effectively aggregated.

It should also be noted that the discriminator may receive as input a processed image and a feature map.

According to a particular embodiment, the discriminator comprises a convolutional neural network.

It has been observed that convolutional neural networks are particularly powerful to perform the discrimination task, and that during training of the generator, gradients are obtained from the discriminator to adapt the generator (for example through the stochastic gradient descent method).

According to a particular embodiment, the method comprises determining a loss taking into account the output of the model for an image and the output of the second portion for a feature map generated by the generator, determining the loss comprising performing a smoothing.

For example, is the model is a model for semantic segmentation, the smoothing is a Label Smoothing Regularization, as disclosed in “Rethinking the inception architecture for computer vision” (C. Szegedy, V. Vanhoucke, S. Ioffe, J. Shlens, and Z. Wojna, CVPR 2016).

According to a particular embodiment, the model is a model to be used for semantic segmentation of images.

In this embodiment, the second portion outputs a semantic segmentation of the image inputted to the model.

According to a particular embodiment, the model comprises a module configured to output a processed image by taking into account:

A: the output of the second portion for a feature map obtained with the first portion on an image,

B: the output of the second portion for a feature map obtained with the generator using A as input to the generator.

It has been observed by the inventors that the use of the generator to obtain processed images A and B to obtain the output of the model can prevent the determination by inference of the images used to train the model.

In fact, the module configured to output a processed image by taking into account A and B can obfuscate the image used as input to the model during training.

The present disclosure also provides a system for training a model to be used for processing images, wherein the model comprises:
a first portion configured to receive images as input and configured to output a feature map,
a second portion configured to receive the feature map outputted by the first portion as input and configured to output a processed image, the system comprising:
a module for training a generator so that the generator is configured to generate a feature map configured to be used as input to the second portion,
a module for generating a plurality of feature maps using the generator,
a module for training the second portion using the feature maps generated by the generator.

This system may be configured to perform all the embodiments of the method as defined above.

The present disclosure also provides a model to be used for processing images, wherein the model has been trained using the method as defined above.

The present disclosure also provides a system for processing images, comprising an image acquisition module and the model as defined above.

The image acquisition module may deliver images that can be processed by the model to perform the processing, for example semantic segmentation.

The present disclosure also provides a vehicle comprising a system for processing images as defined above.

In one particular embodiment, the steps of the method are determined by computer program instructions.

Consequently, the present disclosure is also directed to a computer program for executing the steps of a method as described above when this program is executed by a computer.

This program can use any programming language and take the form of source code, object code or a code intermediate between source code and object code, such as a partially compiled form, or any other desirable form.

The present disclosure is also directed to a computer-readable information medium containing instructions of a computer program as described above.

The information medium can be any entity or device capable of storing the program. For example, the medium can include storage devices such as a ROM, for example a CD ROM or a microelectronic circuit ROM, or magnetic storage devices, for example a diskette (floppy disk) or a hard disk.

Alternatively, the information medium can be an integrated circuit in which the program is incorporated, the circuit being adapted to execute the method in question or to be used in its execution.

### BRIEF DESCRIPTION OF THE DRAWINGS

How the present disclosure may be put into effect will now be described by way of example with reference to the appended drawings, in which:

FIG. 1 is a schematic representation of the model and the generator according to an example,

FIG. 2 is a more detailed representation of the generator accompanied by a discriminator,

FIG. 3 is a schematic representation of a system for training a model according to an example.

FIG. 4 is an exemplary representation of a vehicle including a model according to an example.

### DESCRIPTION OF THE EMBODIMENTS

An exemplary method and system for training a model to be used for semantic segmentation of images will be described hereinafter.

It should be noted that the present disclosure is not limited to semantic segmentation and could be applied to other image processing methods (for example object detection or depth estimation).

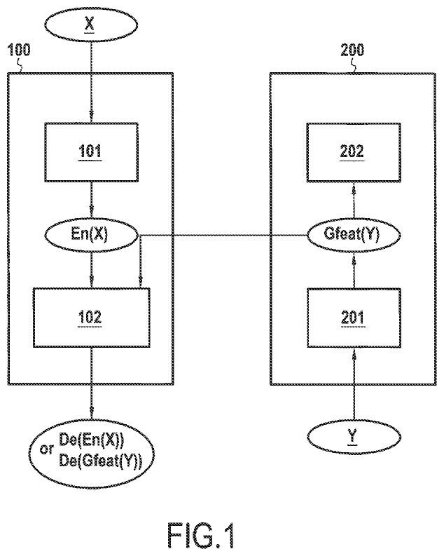

On FIG. 1, a schematic representation of a model 100 to be used for semantic segmentation has been represented. This model may have initially the structure of a convolutional neural network suitable for a task such as semantic segmentation. In order to train the model 100, a training set T={(Xi,Yi)}ᵢ₌₁ⁿ is used wherein Xi denotes an image from a set of n images and Yi denotes predefined semantic segmentations obtained for each image of the set.

The predefined semantic segmentations Yi are layouts which indicate the type of each object visible on the image (the types are chosen among a predefined set of types of objects such as car, pedestrian, road, etc.). By way of example, the predefined semantic segmentations Yi are obtained in a preliminary step in which a user has annotated the images.

During a preliminary training, images Xi are inputted to the model and the output of the model is compared with the semantic segmentations Yi so as to train the network in a manner which is known in itself (for example using the stochastic gradient descent).

In order to improve the training, it is usually desired to have more images to use as input to the model. Generating these images can be done on the basis of a semantic segmentation. However, it has been observed by the inventors of the present disclosure that generating images does not lead to a significant improvement of the efficiency of the model.

In the present example, two consecutive portions of the model 100 are considered: a first portion 101 which receives an image X as input and outputs a feature map En(X), and a second portion 102 which receives the feature map En(X) as input and outputs a semantic segmentation De(En(X)).

The person skilled in the art will be able to determine the location of the separation between the first portion 101 and the second portion 102 according to the obtained improvement in semantic segmentation.

Instead of generating images, a separate model 200 comprising a generator 201 and a discriminator 202 is used. The model 200 provides adversarial generation of feature maps Gfeat(Y) which may be used as input to the second portion 102 of the model 100. To this end, the model comprises a generator 201 and a discriminator 202. The generator generates feature maps on the basis, in the illustrated example, of a semantic segmentation Y.

The implementation of the model 200 is based on the one of document “Toward multimodal image-to-image translation” (J.-Y. Zhu, R. Zhang, D. Pathak, T. Darrell, A. A. Efros, O. Wang, and E. Shechtman, NIPS, 2017). However, as explained above, images are not generated by the generator, and feature maps are generated, which may have a depth larger than 3 (the depth of a red-green-bleu image), and a resolution which is smaller than the one of the images which are inputted to the model 100.

It should be noted that additional inputs may be used for the generator 201. In some embodiments, a random number is also inputted to the generator. This random number may be chosen from a Gaussian distribution and is taken into account by the generator to generate, for a single semantic segmentation Y as input, a plurality of different outputs Gfeat(Y). This approach is known in itself as the latent vector method.

Additional or alternative inputs may be used for obtaining feature maps from the generator.

Also, while the semantic segmentations Yi of the training set T can be used as input to the generator, it is also possible to use semantic segmentations originating from other sources such as:
Graphic engines generating semantic segmentations,
Hard negatives, which are semantic segmentations which are difficult to classify according to a predefined criterion,
Semantic segmentations outputted by the model 100.

These other sources of semantic segmentations may be used during the training of the generator.

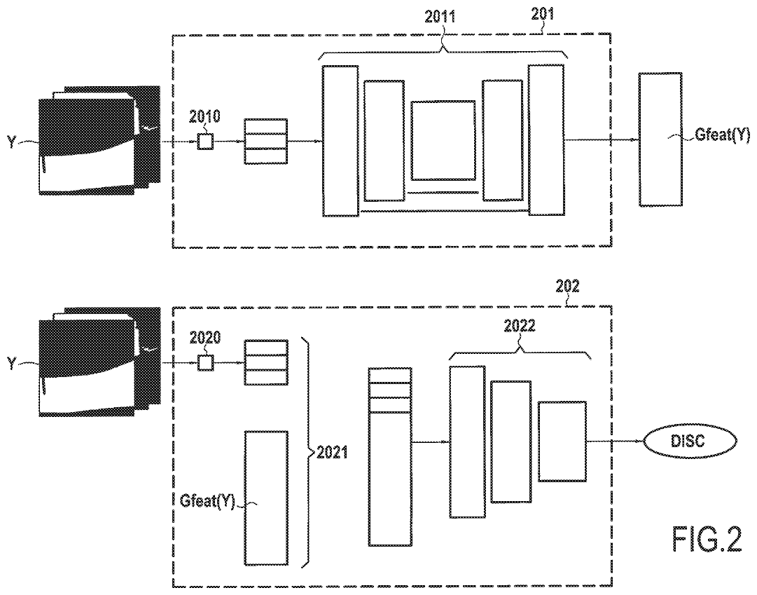

The structure of the generator 201 and of the discriminator 202 will be described in more detail in relation to FIG. 2.

From the above, it appears that the use of the generator will allow having more inputs to the second portion 102. The second portion 102 is trained with two types of feature maps:
En(X) obtained from the first portion 101,
Gfeat(Y) obtained from the generator 201 and which may be called synthetic features.

A loss function may then be defined so as to train the second portion 102 by taking into account En(X) and Gfeat(Y). This is possible because there is a predefined semantic segmentation associated with every feature map En(X) and there is also a predefined semantic segmentation associated with every generated feature map Gfeat(Y).

For example, if only the training set T is used to generate feature maps, the second portion 102 can be trained with the following pairs:
{En(Xi),Yi}ᵢ₌₁ⁿ, and
{Gfeat(Yi),Yi}ᵢ₌₁ⁿ

If the second portion 102 outputs per class (i.e. types of object) probabilities for each pixel (for example after a normalization using the well-known function Softmax), a loss function (in this example a negative log likelihood with regularization for the synthetic features Gfeat(Y) can be used:

L= [symbol] (−log De(En(x)))+ [symbol] (−log De(Gfeat(Y)))

Wherein [symbol] is the expectation (known operator applied to random variables which is a computation of the mean value of all the inputs).

The weights of the second portion 102 can then be adapted so as to be able to better perform semantic segmentation.

It is possible to perform label smoothing regularization during the training of the model 100 (or at least of the second portion 102). To this end, if the per class probabilities for an image X are written, for each class (or label or type of object) k∈{1, . . . , K} as:

$$p i ( k \vert X ) = \frac{exp ( {r}_{i}^{k} )}{{\sum }_{k = 1}^{K} exp ( {r}_{i}^{k} )}$$

With rᵢ^{k} being the un-normalized log probability for the class of index k, at the pixel location of index i; directed to real images. For a generated feature map Gfeat(Y), the per class probabilities are written:

$$p i ( k \vert G f e at ( Y ) ) = \frac{exp ( {s}_{i}^{k} )}{{\sum }_{k = 1}^{K} exp ( {s}_{i}^{k} )}$$

With sᵢ^{k} being the un-normalized log probability for the class of index k, at the pixel location of index i; directed to synthetic or generated features.

It follows that the negative log likelihood of the above equation can be rewritten as

$$L = 𝔼 ( - {\sum }_{i} log p i ( k \vert X ) q r e a l ( k ) ) + 𝔼 ( - {\sum }_{i} log p i ( k \vert X G f e at ( Y ) ) qsy n ( k ) )$$

Wherein qreal(k) and qsyn(k) are weighing functions which can be written using a unified formulation:

$${q}_{ϵ} ( k ) = \{ \begin{matrix}1 - \frac{K - 1}{K} ϵ , k = y \\ \frac{ϵ}{K} , k \neq y\end{matrix}$$

In which ϵ is a value chosen in the range of [0,1] for label smoothing regularization. In the above equation for the negative log likelihood, it is possible to set qreal=q₀ and qsyn=q_{ϵ}. By way of example, E may be set to zero and qsyn may be set at a small value such as 0.0001.

Additionally, it has been observed by the present inventors that the use of the generator for training allows preventing a third party from discovering which images or which set of images have been used to train the model 100.

The model 100 can comprise a module (not represented on the figure) configured to output a semantic segmentation by taking into account:

A: the output of the second portion for a feature map obtained with the first portion on an image De(En(X)),

B: the output of the second portion for a feature map obtained with the generator using A as input to the generator De(G feat (De(En(X)))). More precisely, this module can output a semantic segmentation Ŷ:

Ŷ=M⊙((1−d)×De(En(X))+d×De(Gfeat(De(En(X)))))+(1−M)⊙(De(Gfeat(De(En(X)))))

Wherein d is a factor chosen in the range of [0,1] which represents a level of obfuscation to be performed by the module, and M is a mask indicating the locations wherein there is a difference between De(En(X)) and De(Gfeat(De(En(X)))). The inventors have observed that the above function provides a good level of obfuscation to prevent a third party from determining which images have been used to train the model 100.

FIG. 2 is a schematic representation of the model 200 comprising a generator 201 and a discriminator 202.

The generator 201 comprises a first module 2010 configured to adapt the output dimensions of the generator to the input size of the second portion. In this example, the module 2010 is an atrous spatial pyramid pooling module.

An encoded layout is then obtained and it is inputted to a convolutional network, a U-net 2011 in this example, so as to obtain a generated feature Gfeat(Y).

In the discriminator 202, an atrous spatial pyramid pooling module 2020 is also used to adapt a semantic segmentation in a similar manner than module 2010 described above.

The discriminator further comprises a module 2021 represented by a bracket which concatenates the encoded layout outputted by module 2020 and the corresponding generated feature Gfeat(Y) into an object which will be inputted to a convolutional neural network 2022 which is trained to act as discriminator and output a value DISC. The value DISC is chosen to represent whether the feature is a realistic feature for the inputted semantic segmentation Y.

Using the discriminator and the generator in an adversarial manner provides a training of the model 200 and more precisely of the generator and of the discriminator.

By way of example, a semantic layout on which 20 objects can be classified may have the following dimensions (depth*width*height): 20*713*713. After going through an atrous spatial pyramid pooling module such as module 2010, the encoded layout may have the following dimensions: 384*90*90. For a feature map having dimensions 1024*90*90, the concatenated result has a resolution of 1408*90*90.

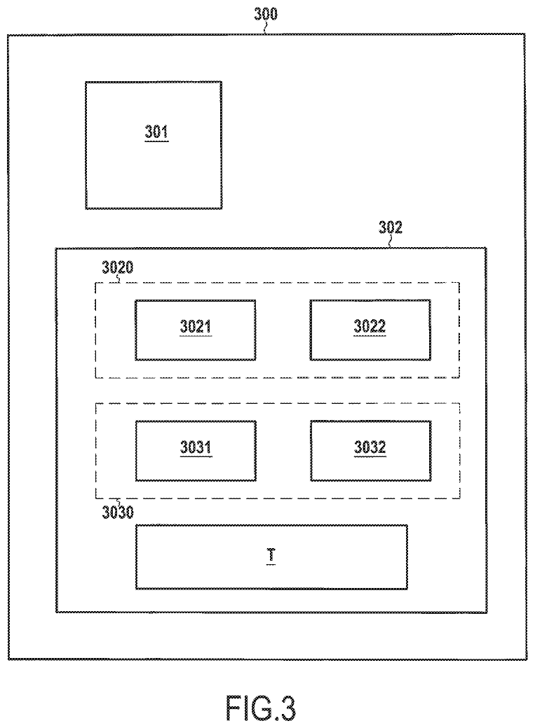

FIG. 3 is a schematic representation of a system for training a model such as the model 100 of FIG. 1.

The system comprises a processor 301 and may have the architecture of a computer.

In a non-volatile memory 302, the system comprises computer program instructions 3020 implementing the model 100 and more precisely instructions 3021 implementing the first portion 101 and instructions 3022 implementing the second portion 102.

The non-volatile memory further comprises computer program instructions 3030 implementing the model 200 and more precisely instructions 3031 implementing the generator 201 and instructions 3032 implementing the discriminator 202.

Finally, the non-volatile memory comprises the training set T as described above in relation to FIG. 1.

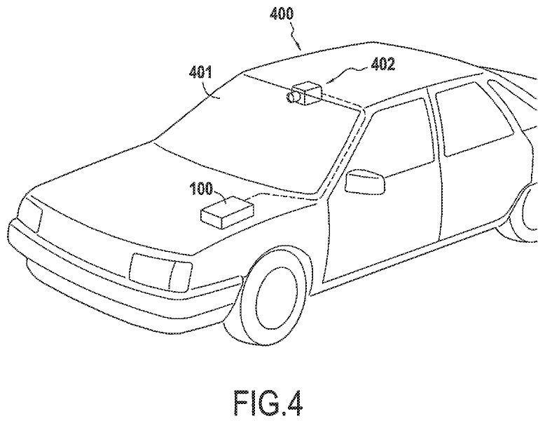

FIG. 4 is a schematic representation of a vehicle 400, for example an automobile, equipped with a system 401 including a model 100 which has been trained as explained above, and an image acquisition module 402 (for example a camera).

In view of the examples described above, it is possible to train a neural network using generated feature maps. The inventors have observed that this generation provides an improvement of the training because the model shows improved performance after training.

More precisely, an improvement has been observed on the PSP-Net dataset disclosed in “Pyramid scene parsing network” (H. Zhao, J. Shi, X. Qi, X. Wang, and J. Jia, CVPR, 2017), or on the Cityscapes dataset disclosed in “The cityscapes dataset for semantic urban scene understanding” (M. Cordts, M. Omran, S. Ramos, T. Rehfeld, M. Enzweiler, R. Benenson, U. Franke, S. Roth, and B. Schiele, CVPR 2016), or on the ADE20K dataset disclosed in “Scene parsing through ade20k dataset” (B. Zhou, H. Zhao, X. Puig, S. Fidler, A. Barriuso, and A. Torralba, CVPR 2017).

These improvements may be measured using the methods known to the person skilled in the art under the names “Pixel Accuracy”, “Class Accuracy”, “Mean Intersection Over Union”, and “Frequent Weighted Intersection Over Union”.

It has also been observed by the inventors that the position of the separation between the first and the second portion can be determined using these methods to measure improvements.

1. A method for training a model to be used for processing images, wherein the model comprises:
a first portion configured to receive images as input and configured to output a feature map,
a second portion configured to receive the feature map outputted by the first portion as input and configured to output a semantic segmentation,
the method comprising:
training a generator so that the generator is configured to generate a feature map configured to be used as input to the second portion,
generating a plurality of feature maps using the generator,
training the second portion using the feature maps generated by the generator.

2. The method of claim 1, wherein the generator is trained with an adversarial training.

3. The method of claim 1, comprising a preliminary training of the model using a set of images and, for each image of the set of image, a predefined processed image.

4. The method of claim 3, wherein training the generator comprises using the predefined processed images as input to the generator.

5. The method of claim 3, wherein training the generator comprises using processed images obtained using the model on images from the set of images.

6. The method of claim 3, wherein training the generator comprises using feature maps obtained using the first portion on images from the set of images.

7. The method according to claim 1, wherein training the generator comprises inputting an additional random variable as input to the generator.

8. The method according to claim 1, wherein the generator comprises a module configured to adapt the output dimensions of the generator to the input size of the second portion.

9. The method according to claim 1, wherein the generator comprises a convolutional network.

10. The method according to claim 2, wherein training the generator with an adversarial training comprises using a discriminator receiving a processed image as input, the discriminator comprising a module configured to adapt the dimensions of the processed image to be used as input.

11. The method according to claim 10, wherein the discriminator comprises a convolutional neural network.

12. The method according to claim 1, comprising determining a loss taking into account the output of the model for an image and the output of the second portion for a feature map generated by the generator, determining the loss comprising performing a smoothing.

13. The method according to claim 1, wherein the model is a model to be used for semantic segmentation of images.

14. The method according to claim 1, wherein the model comprises a module configured to output a processed image by taking into account:
A: the output of the second portion for a feature map obtained with the first portion on an image,
B: the output of the second portion for a feature map obtained with the generator using A as input to the generator.

15. A system for training a model to be used for processing images, wherein the model comprises:
a first portion configured to receive images as input and configured to output a feature map,
a second portion configured to receive the feature map outputted by the first portion as input and configured to output a processed image,
the system comprising:
a module for training a generator so that the generator is configured to generate a feature map configured to be used as input to the second portion,
a module for generating a plurality of feature maps using the generator,
a module for training the second portion using the feature maps generated by the generator.

16. A model to be used for processing images, wherein the model comprises:
a first portion configured to receive images as input and configured to output a feature map,
a second portion configured to receive the feature map outputted by the first portion as input and configured to output a semantic segmentation, and
the model has been trained by:
training a generator so that the generator is configured to generate a feature map configured to be used as input to the second portion,
generating a plurality of feature maps using the generator,
training the second portion using the feature maps generated by the generator.

17. A system for processing images, comprising an image acquisition module and the model according to claim 16.

18. A vehicle comprising a system according to claim 17.

19. (canceled)

20. A non-transitory recording medium readable by a computer and having recorded thereon a computer program including instructions that when executed by a processor cause the processor to train a model to be used for processing images, wherein the model comprises:
a first portion configured to receive images as input and configured to output a feature map,
a second portion configured to receive the feature map outputted by the first portion as input and configured to output a semantic segmentation,
the training comprising:
training a generator so that the generator is configured to generate a feature map configured to be used as input to the second portion,
generating a plurality of feature maps using the generator,
training the second portion using the feature maps generated by the generator.
